(19) United States
(12) Patent Application Publication
(10) Pub. No.: US 2026/0029569 A1
(43) Pub. Date: Jan. 29, 2026

(54) ADJUSTABLE OPTICAL COUPLER

(71) Applicant: AT&T Intellectual Property I, L.P., Atlanta, GA (US)

(72) Inventors: Ricky Perry, Cumming, GA (US); Stewart Barker, Lucas, TX (US); Kirk D. Drane, McKinney, TX (US); Gregory O. Harp, Allen, TX (US)

(73) Assignee: AT&T Intellectual Property I, L.P., Atlanta, GA (US)

(21) Appl. No.: 18/781,006

(22) Filed: Jul. 23, 2024

(51) Int. Cl. G02B 6/02; G02B 6/12

(52) U.S. Cl. CPC G02B 6/02042; G02B 6/12; G02B 2006/12147; G02B 2006/1215

(57) ABSTRACT

Aspects of the subject disclosure may include, for example, a configurable optical signal distribution device including a housing having an upstream optical terminal, a diversion optical terminal, and a group of downstream optical terminals. The configurable device further includes an adjustable optical signal diverter and an adjustable diversion selector coupled to the adjustable optical signal diverter. The adjustable optical signal diverter is configured to direct a selectable portion of a downstream optical signal received at the upstream optical terminal, to an optical splitter. A value of the selectable portion is determined according to an adjustment of the adjustable diversion selector. The optical splitter, in turn, is configured to divide the selectable portion of the downstream optical signal among the group of downstream optical terminals. Other embodiments are disclosed.

### FIELD OF THE DISCLOSURE

The subject disclosure relates to an adjustable optical coupler.

### BACKGROUND

Optical networks are an evolving technology that is driving higher bandwidth and demand for expanded coverage. Such demands require build-out fiber for customer and business broadband, resulting in evolving fiber plant and optical transmission requirements. Optical architectures that utilize optical fiber diversions or “taps,” sometimes referred to as fiber distribution TAP architectures, are becoming increasingly of interest to network operators as a means to reduce the cost of the outside plant fiber deployment.

Fiber distribution TAP architectures may incorporate passive optical TAP components that enable portions of a downstream optical signal to rediverted, e.g., as in a fiber-to-the-home (FTTH) scenarios. For example, a network segment may include a single downstream fiber driven by equipment of a network operator, e.g., an optical line terminal (OLT). The fiber may be deployed over a geographical region, with distributed optical taps positioned, e.g., distributed, along the fiber segment according to subscriber locations and possibly other requirements. For example, passive TAP components include fixed components based on specific power ratios, e.g., unbalanced power ratios and signal split ratios as determined by network and/or subscriber requirements. The specific power ratios may include multiple variants, which must be inventoried, spared managed, and stocked, e.g., on field trucks. This situation presents an increase in potential for not having a spare component in time for network restoral. In some instance using an alternate variant may not be viable due to reduced signal link budget.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of an optical signal distribution system functioning within the communication network of FIG. 1 in accordance with various aspects described herein.

FIG. 2B is a block diagram illustrating an example, non-limiting embodiment of an configurable optical signal distribution device functioning within the optical signal distribution system of FIG. 2A in accordance with various aspects described herein.

FIG. 2C is a block diagram illustrating an example, non-limiting embodiment of an adjustable optical coupling device functioning within the configurable optical signal distribution device of FIG. 2B in accordance with various aspects described herein.

FIG. 2D is a block diagram illustrating another example, non-limiting embodiment of an adjustable optical coupling device functioning within the configurable optical signal distribution device of FIG. 2B in accordance with various aspects described herein.

FIG. 2E is a block diagram illustrating yet another example, non-limiting embodiment of an adjustable optical coupling device functioning within the configurable optical signal distribution device of FIG. 2B in accordance with various aspects described herein.

FIG. 2F depicts an illustrative embodiment of an optical coupling process in accordance with various aspects described herein.

FIG. 2G depicts an illustrative embodiment of an optical coupling process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for a single variant of an adjustable optical signal distribution system, which is configurable to match a multitude of unbalance power and/or split ratios.

One or more aspects of the subject disclosure include a configurable optical signal distribution device. The configurable device includes a housing, which includes an upstream optical terminal, a diversion optical terminal, and a first group of downstream optical terminals. The configurable device further includes an adjustable optical signal diverter, which includes an upstream optical port optically coupled to the upstream optical terminal, a diversion optical port optically coupled to the diversion optical terminal, and a downstream optical port in communication with the first plurality of downstream optical terminals. The configurable device further includes an adjustable diversion selector coupled to the adjustable optical signal diverter and configured to direct a selectable portion of a downstream optical signal presented at the diversion optical terminal to the diversion optical terminal, wherein a value of the selectable portion is determined according to an adjustment of the adjustable diversion selector. The configurable device further includes a first optical signal splitter optically coupled between the diversion optical port and the first group of downstream optical terminals, such that the selectable portion of the downstream optical signal may be divided among the first group of downstream optical terminals.

One or more aspects of the subject disclosure include a process that includes determining requirements for distributing a downstream optical signal to a group of optical terminals. According to the process, a first configuration is determined of a first optical signal distribution module based on the requirements for distributing a downstream optical to obtain a first determined configuration of the first optical signal distribution module. Likewise, a second configuration is determined of a second optical signal distribution module, differing from the first configuration and based on the requirements for distributing the downstream optical to obtain a second determined configuration of the second optical signal distribution module, wherein the first and second optical signal distribution modules are similar. Further according to the process, the first optical signal distribution module is configured according to the first determined configuration to obtain a configured first optical signal distribution module. Likewise, the second optical signal distribution module is configured according to the second determined configuration to obtain a configured second optical signal distribution module. The configured first optical signal distribution module and the configured second optical signal distribution module are operated to distribute selectable portions of a downstream optical signal according to the requirement.

One or more aspects of the subject disclosure include a configurable optical signal distribution system including a first configurable optical signal distribution device. The first configurable optical signal distribution device includes a first upstream optical port configured to receive a downstream optical signal, a first optical tap port in optical communication with a first group of downstream optical terminals and a downstream optical port. The first configurable optical signal distribution device is configured according to a first diversion that directs a first diverted portion of the downstream optical signal toward the first optical tap port and a non-diverted portion of the downstream optical signal toward the downstream optical port. The configurable optical signal distribution system further includes a second configurable optical signal distribution device including a second upstream optical port in communication with the downstream optical port, and a second optical tap port in communication with a second plurality of downstream optical terminals. The second configurable optical signal distribution device is configured according to a second diversion that diverts a second portion of the non-diverted portion of the downstream optical signal toward the second optical tap port. The first and second configurable optical signal distribution devices are structurally identical, while the first and second diversions are different.

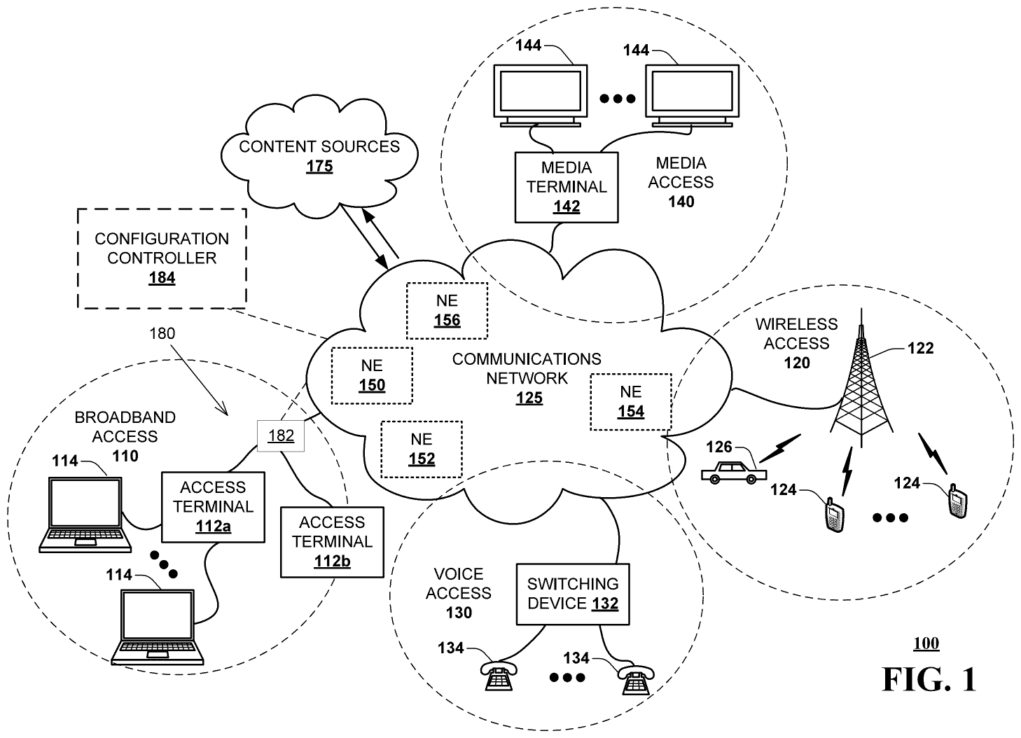

Referring now to FIG. 1, a block diagram is shown illustrating an example, non-limiting embodiment of a communication network 100 in accordance with various aspects described herein. For example, the communication network 100 can facilitate, in whole or in part, incorporation of an optical signal distribution module adapted for adjustment, readjustment, configuration and/or reconfiguration as may be beneficial to deployments within an optical distribution network. The optical distribution network may provide distribution of an optical signal from a source location, e.g., from equipment of a network service provider to multiple destination locations, which may be geographically dispersed e.g., equipment of network service subscribers. In at least some embodiments, the optical signal distribution module may be provided in according to a single format, i.e., a single model and/or catalog part number. Alternatively, or in addition, the optical signal distribution module may be provided according to a limited number of formats, with the ability to support significantly larger number of operational configurations. For example, a single type of optical distribution module, may be adaptable for adjustment, readjustment, configuration and/or reconfiguration to provide optical signal distributions that are tailored according to any combination of numbers and locations of optical signal recipients, optical signal power requirements, optical port multiplication requirements, i.e., signal splitting requirements. In particular, a communications system 125 is presented for providing broadband access 110 to a plurality of data terminals 114 via access terminals 112a, 112b, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications system 125 includes a plurality of network elements (NE) 150, 152, 154, 156, etc., for facilitating the broadband access 110, wireless access 120, voice access 130, media access 140 and/or the distribution of content from content sources 175. The communications system 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications system, e.g., communications network.

In various embodiments, the access terminals 112a, 112b can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications system 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example communication network 100 includes one or more optical signal distribution systems 180 that may utilize one, or perhaps a few, configurable optical distribution modules 182 to manage varied optical signal power distribution and/or optical port multiplication. It is understood that optical signal power distribution may be accomplished according to an optical link budget, in which calculations that take into account available optical source power and optical receiver power requirements, e.g., minimum optical signal levels as may be determined according to signal-to-noise ratios (SNR) and/or energy-per-bit-to-noise ratios (Eb/No), and the like. The optical link budget calculations may also take into account other system parameters, such as optical signal losses, e.g., optical waveguide losses as may result from absorption, waveguide bends and/or discontinuities, equipment insertion losses, reflection losses, and so on.

The configurable optical distribution modules 182 may be adjusted to redirect, i.e., “tap,” a portion of an input optical signal, e.g., a fraction of the input optical signal according to an optical power value, to be directed towards one or more optical terminals, e.g., the access terminals 112a, 112b, generally 112. Alternatively, or in addition, a predetermined portion, such as a percentage, of the optical input signal power may be tapped and distributed to multiple optical terminals, e.g., by way of an optical power divider or optical signal splitter. It is envisioned that such processes may be repeated for multiple configurable optical distribution modules 182, e.g., along an optical network segment as may be fed by a single upstream optical source, e.g., an optical network terminal, providing an input optical signal power level.

In operation, a single optical source, e.g., an optical line terminal (OLT) of a network service provider may inject a broadband optical signal into one end of the optical signal distribution system 180, whereby the injected signal is directed to an arbitrary number of downstream optical devices, e.g., optical network terminals (ONT) of network service subscribers. The configurable optical distribution modules 182 may be configured to facilitate a selectable and/or otherwise adjustable ratio of tapped optical power to input optical power, i.e., an optical power tap ratio. Alternatively, or in addition, the configurable optical distribution modules 182 may be configured to provide a selectable and/or configurable different numbers of optical port multiplications, e.g., applying different values of signal splitting.

It is understood that a configuration of optical distribution network segment may be adjusted according to a corresponding link budget and/or to optimization of one or more related network parameters. Adjustments may include, without limitation, selection of a number of configurable optical distribution modules 182 provided in the optical distribution network segment, adjustment of a respective tapped optical signal power, i.e., a power tap ratio, for each configurable optical distribution module 182, determination of a number of downstream optical ports provided by each of the configurable optical distribution modules 182, and any combination thereof.

In some embodiments, configuration of an optical distribution network segment, e.g., by adjustment and/or configuration of the configurable optical distribution modules 182, may be performed during a network service provisioning process, and allow to remain operating according to an established configuration without further adjustment and/or reconfiguration until some subsequent event, such as a re-provisioning process, a maintenance process, and the like. Accordingly, a single and/or limited number of configurable optical distribution modules 182 may support a substantially larger number of configurations by their ability for adjustment of the tapped power ratio and/or reconfigurations of the number of ports coupled to the same tapped power port. Beneficially, a network operator may deploy and/or maintain network resources with fewer types of devices to be procured, inventoried, maintained, and the like. Additionally, the already deployed configurable optical distribution modules 182 may be reconfigured “in the field” to accommodate network reconfigurations, subsequent network provisioning and/or network maintenance activity, without necessarily having to be replaced.

It is envisioned that in at least some embodiments, the communication network 100 includes an optical distribution network configuration controller 184. In at least some embodiments, the optical distribution network configuration controller is configured to determine a configuration of an optical distribution network segment, e.g., based on available optical signal power levels, numbers of distribution terminals, locations of distribution terminals, optical waveguide losses, and the like. For example, the optical distribution network configuration controller 184 may accept certain input values, such as any of the foregoing design parameters, and provide a proposed network configuration. The network configuration may include any combination of numbers of configurable optical distribution modules 182, corresponding power tap ratios and/or port multiplications or signal splitter configurations. Alternatively, or in addition, the optical distribution network configuration controller 184 may exchange messages with at least some of the configurable optical distribution modules 182. For example, the configurable optical distribution modules 182 may include a communication module to facilitate communication with the optical distribution network configuration controller 184. Example communication exchanges may include reporting messages that identify one or more of an identity of the configurable optical distribution module 182, a current configuration, e.g., a current tap ratio and/or current signal splitter value of the configurable optical distribution module 182. Alternatively, or in addition, communication exchanges may include control messages that instruct a configurable optical distribution module to implement a configuration, e.g., a preferred tap ratio and/or preferred signal splitter value of the configurable optical distribution module 182.

Although such active communication and/or control may be advantageous to facilitate remote monitoring and/or configurations, it may be appreciated that in at least some applications, e.g., passive optical networks, that the configurable optical distribution modules may operate without requiring power, remote monitoring and/or control. In such instances, the various adjustments, readjustments, configurations and/or reconfigurations disclosed herein may be accomplished manually, e.g., by installation, operation and maintenance personnel.

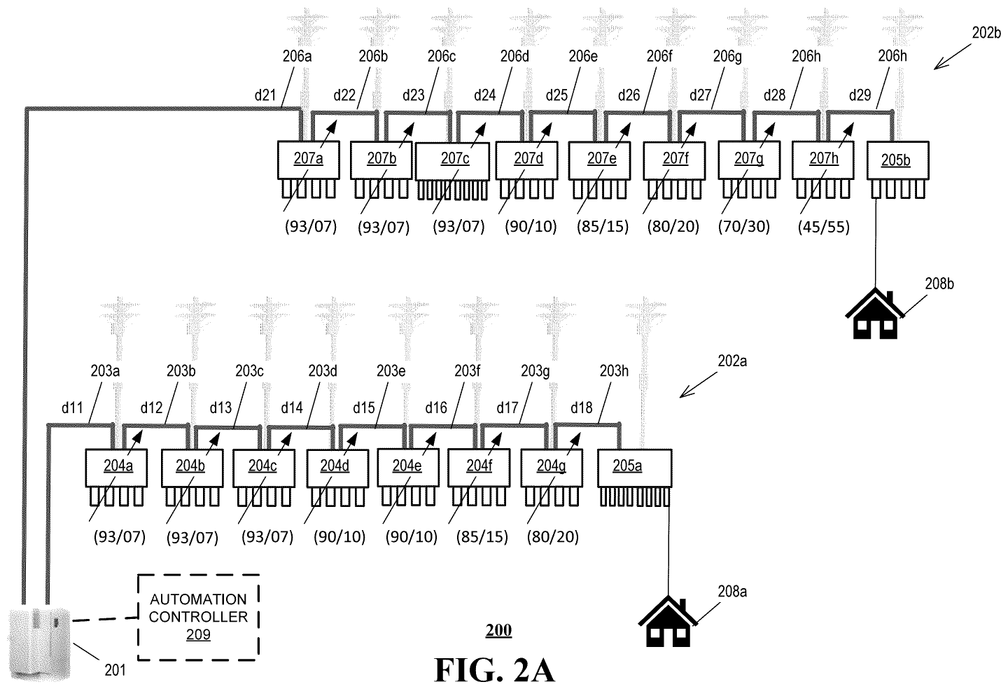

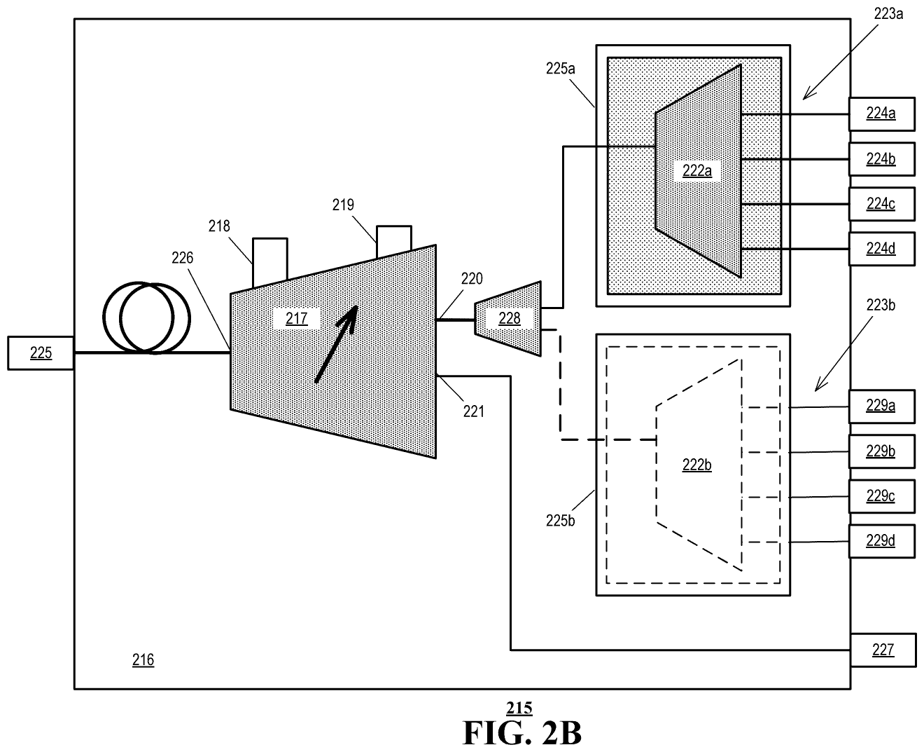

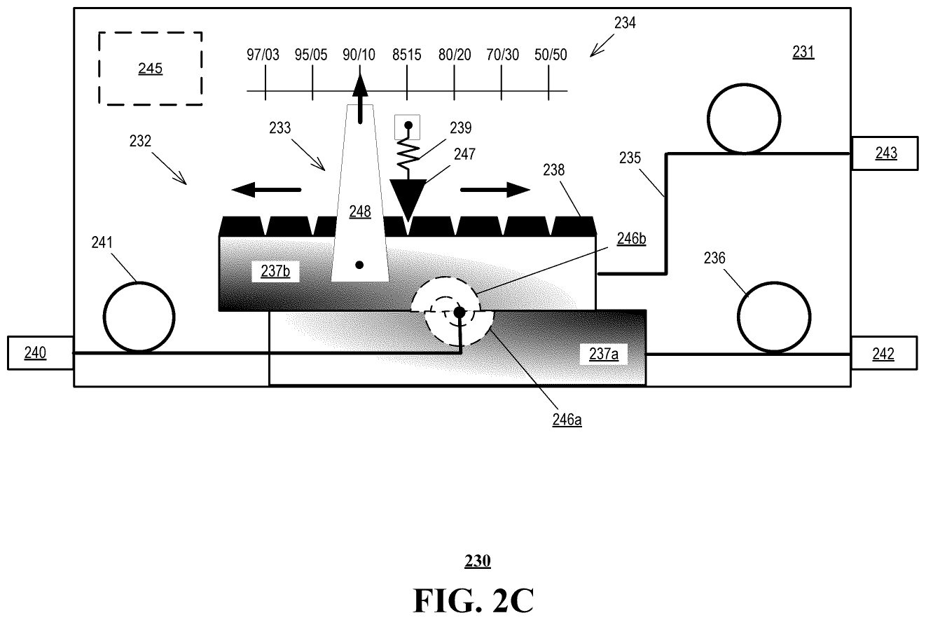

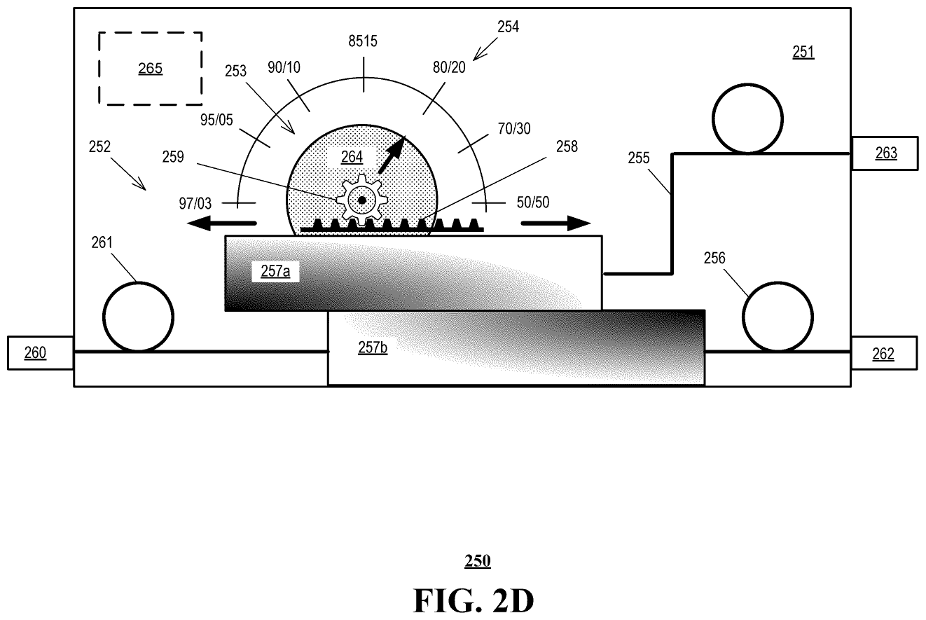

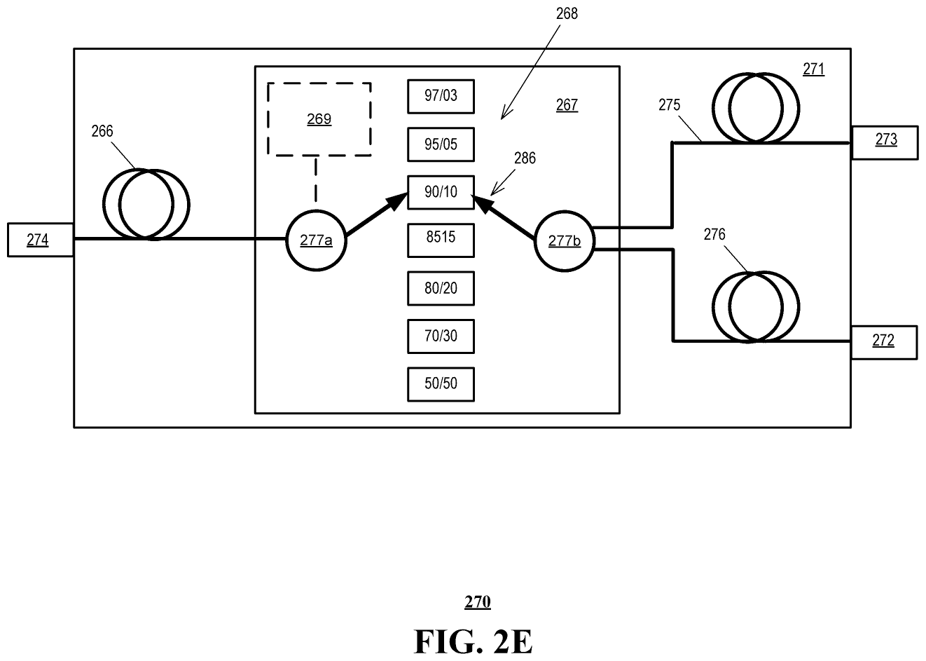

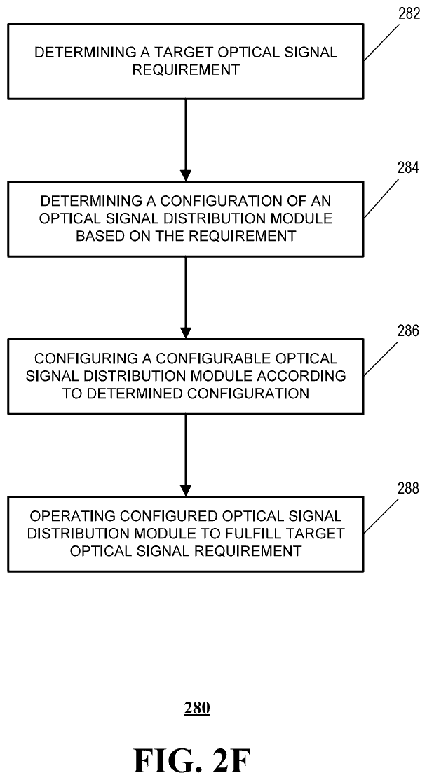

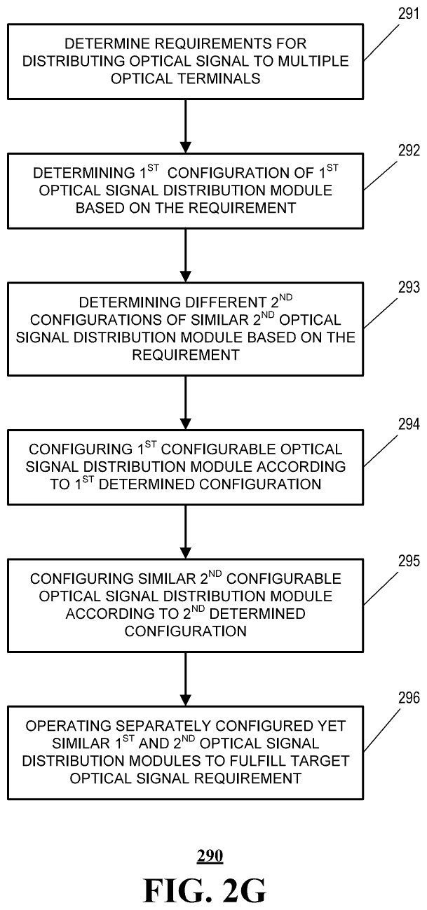

FIG. 2A is a block diagram illustrating an example, non-limiting embodiment of an optical signal distribution system 200 functioning within the communication network 100 of FIG. 1 in accordance with various aspects described herein. The optical signal distribution system 200 includes a first optical distribution network segment 202a configured to support optical communications between an upstream optical terminal 201 and a first group of downstream optical terminals 208a. The optical communications supported by the first optical distribution network segment 202a include a downstream direction, i.e., directed from the upstream optical terminal 201 to one or more of the first group of downstream optical terminals 208a. In at least some embodiments, the optical communications may include an upstream direction, i.e., directed from one or more of the first group of downstream optical terminals 208a and the upstream optical terminal 201. The example optical signal distribution system 200 also includes a second optical distribution network segment 202b configured to support optical communications between the upstream optical terminal 201 and a second group of downstream optical terminals 208b.

According to the illustrative example, the first optical distribution network segment 202a includes a first optical waveguide segment 203a optically coupled between the upstream optical terminal 201 and a first configurable optical signal distribution module 204a. Likewise, a second optical waveguide segment 203b is optically coupled between the first configurable optical signal distribution module 204a and a second optical signal distribution module 204b. The example first optical distribution network segment 202a includes a first group of configurable optical signal distribution modules including seven configurable optical signal distribution modules 204a, 204b, 204c, 204d, 204c, 204f, 204g, generally 204. The first group of optical signal distribution modules 204 are respectively serially interconnected by a first group of optical waveguide segments 203b, 203c, 203d, 203e, 203f, 203g, generally 203, coupled therebetween. In at least some embodiments, the first optical distribution network segment 202a may include a final or terminal downstream optical distribution module 205a. As will be discussed further hereinbelow, each member of the first group of configurable optical signal distribution modules 204 may be configured according to a respective tap ratio, whereas the terminal downstream optical distribution module 205a may not require an adjustable optical tap feature, or even a tap feature at all. For example, the terminal downstream optical distribution module 205a may simply include a portion multiplier function, e.g., signal splitting.

Similarly, the example second optical distribution network segment 202b includes a second group of eight configurable optical distribution modules 207a, 207b, 207c, 207d, 207e, 207f, 207g, 207h, generally 207, respectively serially interconnected by a second group of optical waveguide segments 206b, 206c, 206d, 206e, 206f, 206g, 206h, generally 206. In at least some embodiments, the example second optical distribution network segment 202b may also include a final or terminal downstream optical distribution module 205b. Any number of optical distribution network segments 202a, 202b, generally 202, is conceivable as may be useful to extend and/or otherwise provide network services to different geographic areas, e.g., neighborhoods or communities and/or to extend coverage within a particular geographic area, e.g., extending service coverage along a lengthy street and/or within a densely populated building, building complex and/or community.

Without limitation, the optical waveguide segments 203, 206 may be similar, e.g., the same type of optical waveguide, or different. In at least some embodiments, the optical waveguide segments 203, 206 include optical fibers. The optical fibers may include single mode fibers, multimode fibers and/or combinations of single mode and multimode fibers.

In operation, the optical distribution network segments 202 may be supplied with one or more optical signals, e.g., a downstream-directed optical signal originating at the upstream optical terminal 201. Network services may include, without limitation, communication services, emergency services, streaming media services, broadband services, broadcast media services, broadband internet, and so on. It is envisioned that at least some of the services may be unidirectional, e.g., directed from the upstream optical terminal 201 to one or more downstream optical terminals 208a, 208b, generally 208 or vice versa. Alternatively, or in addition, at least some of the services may be bidirectional, e.g., including optical signals operating in both directions along the same optical waveguide segments 203, 206.

In at least some embodiments, the optical signal distribution system 200 may optionally include a configuration automation controller 209 (shown in phantom). The configuration automation controller 209, when provided, may be configured to facilitate determination of a configuration of the optical signal distribution system 200, e.g., including determination of a configuration of the optical distribution network segments 202a, 202b. It is understood that in at least some embodiments, such automated determinations may be based on available optical signal power levels, numbers of distribution terminals, locations of distribution terminals, optical waveguide losses, and the like. For example, the configuration automation controller 209 may accept certain input values, such as any of the foregoing design parameters, and provide a proposed network configuration. The network configuration may include any combination of numbers of configurable optical signal distribution modules 204, 207 corresponding power tap ratios and/or port multiplications or signal splitter configurations. Alternatively, or in addition, the configuration automation controller 209 may exchange messages with at least some of the configurable optical signal distribution modules 204, 207. For example, the configurable optical signal distribution modules 204, 207 may include a communication module (not shown here) to facilitate communication with the configuration automation controller 209. Example communication exchanges may include reporting messages that identify one or more of an identity of the configurable optical signal distribution module 204, 207, a current configuration, e.g., a current tap ratio and/or current signal splitter value of at least one of the configurable optical signal distribution modules 204, 207. Alternatively, or in addition, communication exchanges may include control messages that instruct at least some of the configurable optical signal distribution modules 204, 207 to implement a configuration, e.g., a preferred tap ratio and/or preferred signal splitter value of the configurable optical signal distribution module 204, 207.

By way of non-limiting example, the upstream optical terminal 201 may represent equipment of a network service provider, which may include, in at least some embodiments, an optical line terminal (OLT). The upstream optical terminal 201 may be configured to inject an optical signal having a coupled input optical power level Pin 1 into a proximal end of a first optical fiber segment 203a coupled between the upstream optical terminal 201 and a first configurable optical signal distribution module 204a. In at least some embodiments the first configurable optical signal distribution module 204a is adjustable to divert a first fraction or ratio R₁, of the coupled input optical power level presented at an upstream terminal of the first configurable optical signal distribution module 204a. The first diverted fraction of the coupled input optical power may be represented by the value P_{Tap_1}. The first diverted fraction of the coupled input optical power represented by Eq. 1 provided below, may be directed to one or more downstream terminal ports.

$${P}_{Tap \_ 1} = {P}_{i {n}_{-} 1} \cdot {R}_{1} \qquad Eq . 1$$

According to the illustrative example, the first optical signal distribution module 204a provides four such downstream terminal ports, e.g., by incorporating a 1×4 optical power splitter, such that the first diverted fraction of the coupled input optical power may be divided by the number of downstream terminal ports N₁, of the first configurable optical signal distribution module, i.e., N₁=4, in this example to represent an optical signal power level P_{Terminal_1} at each of the downstream terminal ports of the first configurable optical signal distribution module 204a, as presented by Eq. 2 provided below:

$${P}_{Terminal \_ 1} = \frac{{P}_{i n} \cdot {R}_{1}}{N} \qquad Eq . 2$$

The non-diverted optical signal power P_{Forward_1}, as represented by Eq. 3 provided below, is directed further downstream via a downstream line terminal of the first configurable optical signal distribution module 204a.

$${P}_{Forward \_ 1} = {P}_{i n} \cdot ( 1 - {R}_{1} ) \qquad Eq . 3$$

The example calculations may be repeated for the second configurable optical signal distribution module 204b, instead using the signal power of the non-diverted optical signal of the preceding stage, i.e., P_{Forward_1}, as the input power level at the upstream terminal and applying a second fraction or ratio R₂ to divert a second portion of the optical signal towards a second group of subscriber terminal ports. The downstream optical signal may be processed in a similar manner at each of the configurable optical signal distribution module 204, until reaching some termination, e.g., the final optical signal distribution device 205. The ratios and/or numbers of terminal ports at each of the configurable optical signal distribution modules 204 may be adjusted and/or configured to ensure that downstream optical terminals, e.g., terminal 208a, are provided with sufficient optical signal levels, e.g., above a minimum threshold, and in at least some embodiments, below some maximum threshold, e.g., within a predetermined operational optical signal power range.

According to the illustrative example, the first configurable optical signal distribution modules 204a of the first optical distribution network segment 202a receives a downstream signal from the upstream optical terminal 201. The first configurable optical signal distribution modules 204a is configured with a first diversion ratio of 93/07, which in at least some embodiments may be defined as a ratio of percentages of through power to diverted power. Accordingly, 7% of the received downstream signal power is diverted and shared among the four downstream terminal ports, while a remaining 93% of the received downstream signal power is injected into a second optical waveguide segment 203b. A second configurable optical signal distribution module 204b receives in input optical signal which is 93% of the original signal, less any additional loss, e.g., attributable to the second optical waveguide segment 203b. The second configurable optical signal distribution module 204b is configured with a second diversion ratio of 93/07. Accordingly, 7% of the received downstream signal power, i.e., 7% of 93% of the original downstream signal power, is diverted and shared among the four downstream terminal ports, while a remaining 93% of the received downstream signal, i.e., 93% of 93% of the original downstream signal power is injected into a third optical waveguide segment 203c. The process continues in a like manner until any remaining downstream optical signal is distributed to user equipment via the terminal downstream optical distribution module 205a. A similar analysis would also apply to the second optical distribution network segment.

It is understood that the ratios may be determined during an analysis and/or design and/or engineering phase in which one or more link budgets may be used to distribute available downstream optical signal power to downstream user equipment, which equipment may be geographically distributed. In at least some embodiments, the analysis and/or design and/or engineering phase may be optimized according to one or more design parameters. By way of example, design parameters may include one or more of optical signal power budget, numbers and/or lengths of optical waveguide, e.g., optical fiber, implementation costs, maintenance costs, revenue, and the like. It is understood further that the analysis and/or design and/or engineering phase may be performed during an initial build out, e.g., deployment of an optical distribution network segment. Alternatively, or in addition, the analysis and/or design and/or engineering phase may be performed during an expansion and/or reconfiguration of an existing optical distribution network segment.

FIG. 2B is a block diagram illustrating an example, non-limiting embodiment of a configurable optical signal distribution device 215 functioning within the optical signal distribution system 200 of FIG. 2A in accordance with various aspects described herein. The configurable optical signal distribution device 215 includes a housing 216 containing at least one adjustable optical coupler 217 and in at least some embodiments, at least a first optical splitter and/or combiner 222a. The adjustable optical coupler 217 includes an upstream terminal 226, which may be optically coupled to an upstream terminal 225 via an internal optical waveguide, e.g., an optical fiber. The upstream terminal 225 may be adapted to receive a downstream optical signal having a received input optical signal power Pin 1. The adjustable optical coupler 217 further includes a downstream diverted terminal 220 and a downstream pass-through terminal 221.

In at least some embodiments, the adjustable optical coupler 217 includes a diversion ratio adjustment controller, which may also be referred to as a tap ratio adjustment controller 218. Adjustment of the tap ratio adjustment controller 218 adjusts a level and/or amount of a downstream optical signal received at the upstream terminal 225, which may be diverted and/or tapped to obtain a diverted and/or tapped portion of the downstream optical signal, directed towards the downstream diverted terminal 220. A remaining portion, e.g., an undiverted and/or untapped portion of the downstream optical signal received at the upstream terminal 225 may be directed to the downstream pass-through terminal 221. In at least some embodiments, an optical power level of the downstream optical signal received at the upstream terminal 225 is approximately equal to a sum of the diverted or tapped portion of the downstream optical signal and the undiverted and/or untapped portion of the downstream optical signal. It is understood that there may be some amount of insertion loss attributable to other factors, such as absorption losses, reflection losses, and the like as introduced by the adjustable optical coupler 217.

In at least some embodiments, the adjustable optical coupler 217 includes a tap ratio indicator 219. For example, the tap ratio indicator 219 may provide an indication of a setting of the tap ratio adjustment controller 218. The indication may be a visual indication, e.g., as provided by a dial, a meter, a switch position, and the like. Indications may include numeric values, e.g., indicative of a split ratio. Alternatively, or in addition, the visual indication may include an electrical signal as may be presented to a display device.

According to the illustrative embodiment, the downstream pass-through terminal 221 of the adjustable optical coupler 217 may be optically coupled to a pass-through terminal 227 of the housing 216 via an internal optical waveguide, e.g., an optical fiber. The downstream diverted terminal 220 of the adjustable optical coupler 217 may be optically coupled to at least the first optical splitter and/or combiners 222a, e.g., via an internal optical waveguide, e.g., an optical fiber. The first optical splitter and/or combiner 222a, in turn, may be configured with an input configured to receive at least a first portion of the downstream diverted signal. The first optical splitter and/or combiner 222a may be further configured to split and/or otherwise divide the received first portion of the downstream diverted signal to obtain multiple divisions according to a splitter ratio. For example, a 1×N splitter splits an input signal into N output signals. According to the illustrative example, the first optical splitter and/or combiner 222a provides a 1×4 split ratio, such that received first portion of the downstream diverted signal is divided into four diverted and divided optical output signals. These signals may be presented at corresponding downstream diverted and divided terminals of the first optical splitter and/or combiner 222a that are optically coupled, e.g., via a first group of internal optical waveguides 223a, to a first group corresponding diverted and divided optical output terminals 224a, 224b, 224c, 224d, generally 224 of the housing 216.

In at least some embodiments and according to the illustrative example, the housing 216 further includes an expansion optical splitter and/or combiner receiving area 225b. The expansion optical splitter and/or combiner receiving area 225b may be configured to receive a second optical splitter combiner 222b. For example, the expansion optical splitter and/or combiner receiving area 225b may include one or more of an optical splitter and/or combiner attachment mechanism, such as a mounting bracket, a socket, a slot, a compartment, and so on. In at least some embodiments, the housing 216 may include a default optical splitter and/or combiner receiving area 225a. The default expansion optical splitter and/or combiner receiving area 225a may be configured to receive the first optical splitter combiner 222a and may include, without limitation, one or more of an optical splitter and/or combiner attachment mechanism, such as a mounting bracket, a socket, a slot, a compartment, and so on.

The expansion optical splitter and/or combiner 222b, when provided, may be further configured to split and/or otherwise divide the received first portion of the downstream diverted signal to obtain multiple divisions according to a splitter ratio. For example, a 1×M splitter splits an input signal into M output signals. According to the illustrative example, the second optical splitter and/or combiner 222b also provides a 1×4 split ratio, such that received first portion of the downstream diverted signal is divided into four diverted and divided optical output signals. These signals may be presented at corresponding downstream diverted and divided terminals of the second optical splitter and/or combiner 222b that are optically coupled, e.g., via a second group of internal optical waveguides 223b to a second group of corresponding diverted and divided optical output terminals 229a, 229b, 229c, 229d, generally 229 of the housing 216.

In at least some embodiments, the 215 may include at least one optical signal router 228, e.g., a power splitter, configured to split and/or combine upstream and/or downstream optical signals to and/or from the multiple optical splitters and/or combiners 222. In at least some embodiments, the optical signal router 228 may be engaged responsive to incorporation of a second and/or subsequent splitter and/or combiner modules 222.

It is envisioned that in at least some embodiments, the housing 216 may be configured one or more additional expansion optical splitter and/or combiner receiving areas may be provided to optionally accommodate additional optical splitter and/or combiners. Alternatively, or in addition, the default optical splitter and/or combiner 222a may be positioned, housed, connected and/or otherwise secured in a corresponding default optical splitter and/or combiner receiving area 225a. In some embodiments, a second optical splitter combiner 222b, sometimes identified as an expansion optical splitter combiner, is identical to the default optical splitter combiner 222a. In this manner, the configured number of downstream ports or terminals may be configured according to the number and/or type of optical splitter combiners provided within the housing 216. It is understood that any of the optical signal divisions and/or splits may be performed according to a uniform division, e.g., a 1×N splitter provides N outputs each having 1/N^{th} portion of a downstream signal. Alternatively, or in addition, at least some of the optical splitter and/or combiners 222 may be configured according to a nonuniform division.

In at least some embodiments, the selectable tap ratio splitter may include one or more internal, optical signal routers and/or splitters configured to direct respective portions of the diverted downstream signal to corresponding optical splitter and/or combiners 222. It is worth noting here that although many of the examples describe a downstream signal flow, e.g., from a headend OLT to a group of ONTs, it is understood that in at least some embodiments, the configurable optical signal distribution device 215 may be configured to accommodate upstream optical signals, e.g., directed from one or more of the ONTs to the headend OLT.

FIG. 2C is a block diagram illustrating an example, non-limiting embodiment of an adjustable optical coupling device 230 functioning within the configurable optical signal distribution device 215 of FIG. 2B in accordance with various aspects described herein. In at least some embodiments, the adjustable optical coupling device 230 includes a housing 231, which may be configured with one or more optical interconnection terminals. According to the illustrative example, the housing 231 includes an upstream optical terminal 240, a pass-through optical terminal 242 and at least one diverted optical terminal 243, sometimes referred to as a drop optical terminal.

In more detail, the adjustable optical coupling device 230 includes an adjustable optical signal diverter 232. In at least some embodiments the adjustable optical signal diverter 232 includes at least two optical channel assemblies 237a, 237b, generally 237. The first optical channel assembly 237a includes a first optical waveguide segment 246a, which is optically coupled at one end to the upstream optical terminal 240 via an internal upstream optical waveguide 241 and at another end to the pass-through optical terminal 242 via an internal pass-through optical waveguide 236. The second optical channel assembly 237b includes a second optical waveguide segment 246b, which is optically coupled to the diverted optical terminal 243 via an internal diverted optical waveguide 235.

In at least some embodiments, the adjustable optical signal diverter 232 is configured to apply an adjustable optical coupling between the first and second optical waveguide segments 246a, 246b. For example, the first and second optical waveguide segments may include optical fiber segments in which at least a portion of an optical cladding may be removed, e.g., partially exposing a portion of the optical fiber core. The optical channel assemblies 237a, 237b may be arranged such that the at least partially exposed optical fiber cores are adjacent and at least partially overlapping. In this configuration, the optical coupling may be accomplished at least in part by partial exposure of the optical cores of the first and second optical waveguide segments 246a, 246b. A coupled portion of a downstream optical signal received at the upstream optical terminal 240 may be directed to the diverted optical terminal 243 through the internal diverted optical waveguide 235, while any remaining uncoupled portion of the downstream optical signal may be directed to the pass-through optical terminal 242 via the internal pass-through optical waveguide 236. Other configurations that provide controllable optical coupling may include, without limitation, controllable bends in an optical fiber, e.g., to couple at least a portion of the optical signal power through the cladding.

In at least some embodiments, adjustable optical signal diverter 232 includes a diverter ratio adjustment controller assembly 233, which may be configured to impart a controllable adjustment, e.g., relative positioning between the first and second optical channel assemblies 237a, 237b. According to the illustrative example, the first optical channel assembly 237a may be fixedly secured with respect to the housing 231, while the second optical channel assembly 237b may be positionable by way of the diverter ratio adjustment controller assembly 233.

For example, the diverter ratio adjustment controller assembly 233 may include a notched member 238 secured to the second optical channel assembly 237b. The notched member 238 may include an arrangement of notches at predetermined locations, which in at least some embodiments, may be associated with predetermined diversion ratios. In at least some embodiments, the associations may be determined according to a calibration process. The notches may be exposed to a detent 247 configured to engage the notches in a releasable manner, e.g., securing the second optical channel assembly 237b in place with respect to the first optical channel assembly 237a when engaged, while also permitting a repositioning. For example, the detent 247 may be couped to a resilient member, e.g., a spring 239 configured to urge the detent 247 against a surface of the notched member 238. The example diverter ratio adjustment controller assembly 233 may further include a lever 248, which may be manually controlled, e.g., by an operator, to position and/or reposition the second optical channel assembly 237b with respect to the first optical channel assembly 237a in order to provide and/or otherwise achieve a particular diverted signal ratio, e.g., as may have been determined during an analysis and/or engineering and/or design phase and/or as may have been determined according to an installation phase.

In at least some embodiments, the diverter ratio adjustment controller assembly 233 includes an indicator 234. The indicator 234 may be configured to provide an observable indication of the relative displacements of the first and second optical channel assemblies 237a, 237b and/or an observable indication of a ratio of the diverted signal to the input signal and/or to the pass-through signal, and the like. According to the example embodiment, the indicator 234 may include a linear scale identifying ratios of pass-through to diverted optical signal power percentages. The lever 248 may include a needle, arrow, extension, line, and the like, which may be aligned and/or otherwise calibrated to ensure an alignment of the lever 248 with the linear scale of the indicator 234 is a substantially true and/or reliable representation of the resulting configured optical signal coupling arrangement.

It is understood that the adjustable optical coupling device 230 may be configured and/or otherwise operated in a passive manner, e.g., providing for manual configuration without necessarily requiring electrical power and/or remote monitoring or control, as may be advantageous in passive optical network (PON) applications. It is envisioned that in at least some embodiments, the adjustable optical coupling device 230 may include an automation module 245 (shown in phantom). The automation module 245 may be operable temporarily during an installation and/or maintenance and/or configuration and/or adjustment phase. For example, a technician may temporarily apply power to the adjustable optical coupling device 230 to operate the diverter ratio adjustment controller assembly 233, e.g., via the automation module 245 to automatically operate the diverter ratio adjustment controller assembly 233, e.g., servo motors. It is understood that the automation module 245 may further provide an automated indication e.g., via an indication signal and/or display related to the configuration.

In at least some embodiments, the adjustable optical coupling device 230 may be powered by any combination of utility power, battery power, power over optical and the like. The power may be used to power the automation module 245, which may include a communication function adapted to report status of the adjustable optical coupling device 230, e.g., a current configuration and/or to permit remote control of the adjustable optical coupling device 230.

FIG. 2D is a block diagram illustrating another example, non-limiting embodiment of an adjustable optical coupling device 250 functioning within the configurable optical signal distribution device 215 of FIG. 2B in accordance with various aspects described herein. In at least some embodiments, the adjustable optical coupling device 250 includes a housing 251, which may be configured with one or more optical interconnection terminals. According to the illustrative example, the housing 251 includes an upstream optical terminal 260, a pass-through optical terminal 262 and at least one diverted optical terminal 263, sometimes referred to as a drop optical terminal.

In more detail, the adjustable optical coupling device 250 includes an adjustable optical signal diverter 252. In at least some embodiments the adjustable optical signal diverter 252 includes at least two optical channel assemblies 257a, 257b, generally 257. The optical channel assemblies 257a, 257b may include optical waveguide segments operable as discussed in the preceding example. The first optical channel assembly 257a may be coupled at one end to the upstream optical terminal 260 via an internal upstream optical waveguide 261 and at another end to the pass-through optical terminal 262 via an internal pass-through optical waveguide 266. The second optical channel assembly 267b may be optically coupled to the diverted optical terminal 263 via an internal diverted optical waveguide 256.

In at least some embodiments, the adjustable optical signal diverter 252 is configured to apply an adjustable optical coupling between first and second optical waveguide segments of the first and second optical channel assemblies 257, e.g., as describe in the preceding example.

In at least some embodiments, the adjustable optical signal diverter 252 includes a diverter ratio adjustment controller assembly 253, which may be configured to impart a controllable adjustment, e.g., relative positioning between the first and second optical channel assemblies 257a, 257b. According to the illustrative example, the first optical channel assembly 257a may be fixedly secured with respect to the housing 251, while the second optical channel assembly 257b may be positionable by way of the diverter ratio adjustment controller assembly 253.

For example, the diverter ratio adjustment controller assembly 253 may include a rack-and-pinion arrangement in which a first geared portion, e.g., a rack gear 258, is secured to the second optical channel assembly 257b. The rack gear 258 may include a linear arrangement of gear teeth. The rack gear 258 may be exposed to another gear, e.g., a pinion gear 259 configured to engage the gear teeth of the rack gear 258 in a controllable manner, e.g., securing the second optical channel assembly 257b in place with respect to the first optical channel assembly 257a when engaged, while also permitting a repositioning. The example diverter ratio adjustment controller assembly 253 may further include a knob 264, e.g., coupled to the pinion gear 259, which may be manually controlled, e.g., by an operator, to position and/or reposition the second optical channel assembly 257b with respect to the first optical channel assembly 257a in order to provide and/or otherwise achieve a particular diverted signal ratio, e.g., as may have been determined during an analysis and/or engineering and/or design phase and/or as may have been determined according to an installation phase.

In at least some embodiments, the diverter ratio adjustment controller assembly 253 includes an indicator 254. The indicator 254 may be configured to provide an observable indication of the relative displacements of the first and second optical channel assemblies 257a, 257b and/or an observable indication of a ratio of the diverted signal to the input signal and/or to the pass-through signal, and the like. According to the example embodiment, the indicator 254 may include a rotary scale identifying ratios of pass-through to diverted optical signal power percentages. The knob 264 may include a needle, arrow, extension, line, and the like, which may be aligned and/or otherwise calibrated to ensure an alignment of the knob 264 with the rotary scale of the indicator 254 is a substantially true and/or reliable representation of the resulting configured optical signal coupling arrangement.

It is understood that the adjustable optical coupling device 250 may be configured and/or otherwise operated in a passive manner, e.g., providing for manual configuration without necessarily requiring electrical power and/or remote monitoring or control, as may be advantageous in passive optical network (PON) applications. It is envisioned that in at least some embodiments, the adjustable optical coupling device 250 may include an automation module 265 (shown in phantom). The automation module 265 may be operable temporarily during an installation and/or maintenance and/or configuration and/or adjustment phase. For example, a technician may temporarily apply power to the adjustable optical coupling device 250 to operate the diverter ratio adjustment controller assembly 253, e.g., via the automation module 265 to automatically operate the diverter ratio adjustment controller assembly 253, e.g., servo motors. It is understood that the automation module 265 may further provide an automated indication e.g., via an indication signal and/or display related to the configuration.

In at least some embodiments, the adjustable optical coupling device 250 may be powered by any combination of utility power, battery power, power over optical and the like. The power may be used to power the automation module 265, which may include a communication function adapted to report status of the adjustable optical coupling device 250, e.g., a current configuration and/or to permit remote control of the adjustable optical coupling device 250.

It is envisioned that the adjustable optical signal diverter 252 and/or the adjustment control assembly 253 may include various combinations mechanical configurations, such as frictional engagements, notch and detent arrangements, geared engagements, screw-type arrangements, levered arrangements, pulley arrangements, and so on.

FIG. 2E is a block diagram illustrating yet another example, non-limiting embodiment of an adjustable optical coupling device 270 functioning within the configurable optical signal distribution device 215 of FIG. 2B in accordance with various aspects described herein. In at least some embodiments, the adjustable optical coupling device 270 includes a housing 271, which may be configured with one or more optical interconnection terminals. According to the illustrative example, the housing 271 includes an upstream optical terminal 274, a pass-through optical terminal 272 and at least one diverted optical terminal 273, sometimes referred to as a drop optical terminal.

In more detail, the adjustable optical coupling device 270 includes an adjustable optical signal diverter 267. In at least some embodiments the adjustable optical signal diverter 267 includes at least two optical switches 277a, 277b, generally 277. The adjustable optical signal diverter 267 may include a group of predetermined optical diverter modules 268 adapted to a predetermined arrangement of optical signal diversion ratios. The first optical switch 277a may be coupled at one end to the upstream optical terminal 274 via an internal upstream optical waveguide 266 and at another end to the pass-through optical terminal 272 via an internal pass-through optical waveguide 276. The second optical switch 277b may be optically coupled to the diverted optical terminal 273 via an internal diverted optical waveguide 275.

In at least some embodiments, the adjustable optical signal diverter 267 is configured to apply a selectable one of the predetermined optical diverter modules 268. For example, the first and second optical switches 277a, 277b may be arranged in tandem, such that adjustment of one of the switches, e.g., the first switch 277a, also adjusts the other one of the switches, e.g., the second switch 277b to ensure optical signal continuity during any adjustment, configuration and/or reconfiguration of the adjustable optical signal diverter 267.

In at least some embodiments, the diverter ratio adjustment controller assembly 253 includes an indicator 254. The indicator 254 may be configured to provide an observable indication of the relative displacements of the first and second optical channel assemblies 257a, 257b and/or an observable indication of a ratio of the diverted signal to the input signal and/or to the pass-through signal, and the like. According to the example embodiment, the indicator 286 may include an indication of a selected one of the group of predetermined optical diverter modules 268, e.g., according to a position of the switch.

It is understood that the adjustable optical coupling device 270 may be configured and/or otherwise operated in a passive manner, e.g., providing for manual configuration without necessarily requiring electrical power and/or remote monitoring or control, as may be advantageous in passive optical network (PON) applications. It is envisioned that in at least some embodiments, the adjustable optical coupling device 270 may include an automation module 269 (shown in phantom). The automation module 269 may be operable temporarily during an installation and/or maintenance and/or configuration and/or adjustment phase. For example, a technician may temporarily apply power to the adjustable optical coupling device 270 to operate the first and second optical switches 277a, 277b, e.g., via the automation module 269 to automatically operate selection among the group of predetermined optical diverter modules 268, e.g., servo motors. It is understood that the automation module 269 may further provide an automated indication e.g., via an indication signal and/or display related to the configuration.

FIG. 2F depicts an illustrative embodiment of an optical coupling process 280 in accordance with various aspects described herein.

According to the example optical coupling process 280, a target optical signal requirement is determined at 282. The optical signal requirement may include identification of a number of downstream terminals, e.g., optical network terminals (ONTs) at subscriber premises to be serviced by a downstream optical signal, e.g., provided by an optical line terminal (OLT) of a network operator. Alternatively, or in addition, the requirements may include geographic locations of the downstream terminals, operational requirements related to delivery of services via the downstream optical signal, e.g., KPIs, ONT received signal thresholds, and the like.

According to the example optical coupling process 280, a configuration of an optical signal distribution module is determined at 284, based on the requirement. Configuration of the optical signal distribution module may include operation of an adjustable coupling device configured to provide a selectable amount of coupling at a network segment tap location. It is understood that power requirements at the network segment tap location may be determined at least in part based on one or more of optical signal power requirements of ONTs being serviced from the tap location, e.g., minimum received signal thresholds, the number of ONTs being serviced from the tap location, available optical signal at the tap location, optical fiber lengths, losses, and so on.

According to the example optical coupling process 280, a configurable optical signal distribution module is configured at 286, according to determined configuration. For example, in at least some embodiments, an adjustable control, such as a knob, a lever, a switch, may be manually manipulated to achieve the determined configuration. It is envisioned that an indicator may be provided to facilitate adjustment of the adjustable control. Accordingly, an operator may “dial in” and/or otherwise select the desired configuration according to the indicator. Although manual operation is discussed in many of the examples provided herein, it is envisioned that automation may be employed, e.g., in one or more of an adjustment of the adjustable control and/or observing an indication of a setting of the adjustable control.

According to the example optical coupling process 280, the configured optical signal distribution module is operated at 288, to fulfill target optical signal requirement. It is envisioned that once the configurable components have been adjusted and/or otherwise configured, the network may operate without further intervention, unless and until a network reconfiguration is necessary and/or a maintenance issue, such as a device failure.

FIG. 2G depicts an illustrative embodiment of an optical coupling process 290 in accordance with various aspects described herein. According to the example optical coupling process 290, requirements for distributing optical signal to multiple optical terminals are determined at 291. The multiple optical terminals may be determined according to a network analysis, engineering and/or design phase in which subscribers are provided with network services via an optical network. In at least some embodiments, the optical network employs a TAP architecture in which a single fiber originating at a network operator device is directed toward a target service area. A multitude of distribution nodes or taps may be identified, e.g., based on subscriber locations, subscriber requirements, system power budgets and the like.

According to the example optical coupling process 290, the first configuration of a first optical signal distribution module is determined at 292, based on the requirement. For example, the first optical signal distribution module may represent a first tap, i.e., closest to the network operator equipment providing a downstream optical signal. According to the example optical coupling process 290, a different, second configurations of a similar second optical signal distribution module is determined at 293, based on the requirement. For example, the second optical signal distribution module may represent a second tap, i.e., second closest to the network operator equipment and driven by a downstream optical signal from the first tap. It is understood that in at least some embodiments, the downstream optical signal obtained from a tap includes a remaining untapped portion of an optical signal received by the tap.

According to the example optical coupling process 290, a first configurable optical signal distribution module is configured at 294, according to the first determined configuration and the similar second configurable optical signal distribution module is configured at 295 according to the second determined configuration. Configurations may include any of the various examples provided herein, e.g., including adjustments of diverted or tapped optical signal power levels or ratios, numbers of subscribers serviced by each tap and the like.

According to the example optical coupling process 290, the separately and differently configured, yet similar first and second optical signal distribution modules are operated at 296 to fulfill the target optical signal requirement. Beneficially, a single type of optical signal distribution module may service a variety of different configurations, e.g., different tap ratios, different numbers of terminals serviced by each tap and so on. Consequently, a network operator may procure, install, service and spare fewer devices, e.g., a single type of device, despite the requirement for different performance parameters.

While for purposes of simplicity of explanation, the respective processes are shown and described as a series of blocks in FIGS. 2F and 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The various devices, systems, processes and techniques disclosed herein introduce an enhanced ability to leverage variable coupling, including variable directional coupling, into the optical TAP components with a resulting benefit of having a single variant, or perhaps a limited, small number of variants, that are adjustable and/or otherwise configurable to match virtually any unbalance power and split ratio requirements. These adjustable and/or configurable optical signal distribution devices include variable optical TAP and splitter combinations that reduce restoral time to almost instant or as fast as the field engineer can swap out the component, while also alleviating other hinderances associated with using fixed ratio devices. Other embodiments are described in the subject disclosure.

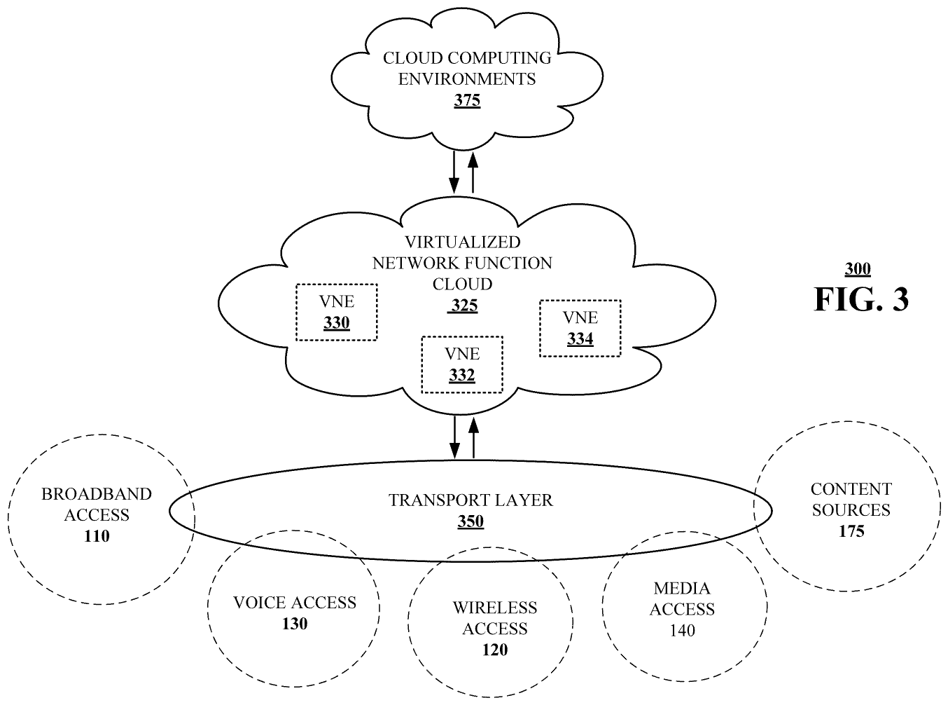

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication network 100, the subsystems and functions of systems and devices 200, 215, 230, 250, 270 and processes 280, 290 presented in FIGS. 1, 2A, 2B, 2C, 2D, 2E, 2F, 2G and 3. For example, virtualized communication network 300 can facilitate in whole or in part implementation of optical signal distribution modules adapted for adjustment, readjustment, configuration and/or reconfiguration as may be beneficial to deployments within an optical distribution network. The virtualized communication network 300 may provide distribution of an optical signal from a source location, e.g., from equipment of a network service provider to multiple destination locations, which may be geographically dispersed e.g., equipment of network service subscribers. In at least some embodiments, the optical signal distribution module may be provided in according to a single format, i.e., a single model and/or catalog part number. Alternatively, or in addition, the optical signal distribution module may be provided according to a limited number of formats, with the ability to support significantly larger number of operational configurations. For example, a single type of optical distribution module, may be adaptable for adjustment, readjustment, configuration and/or reconfiguration to provide optical signal distributions that are tailored according to any combination of numbers and locations of optical signal recipients, optical signal power requirements, optical port multiplication requirements, i.e., signal splitting requirements.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

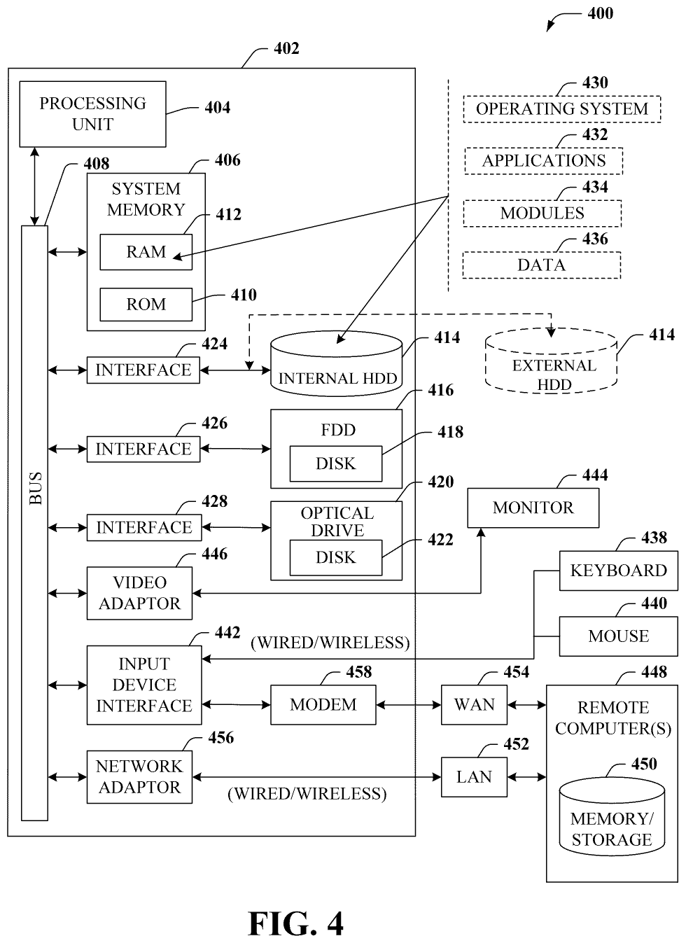

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminals 112a, 112b, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part implementation of optical signal distribution modules adapted for adjustment, readjustment, configuration and/or reconfiguration as may be beneficial to deployments within an optical distribution network. The computing environment 400 may facilitate distribution of an optical signal from a source location, e.g., from equipment of a network service provider to multiple destination locations, which may be geographically dispersed e.g., equipment of network service subscribers. In at least some embodiments, the optical signal distribution module may be provided in according to a single format, i.e., a single model and/or catalog part number. Alternatively, or in addition, the optical signal distribution module may be provided according to a limited number of formats, with the ability to support significantly larger number of operational configurations. For example, a single type of optical distribution module, may be adaptable for adjustment, readjustment, configuration and/or reconfiguration to provide optical signal distributions that are tailored according to any combination of numbers and locations of optical signal recipients, optical signal power requirements, optical port multiplication requirements, i.e., signal splitting requirements as may be controlled at least in part according to the computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

Any power supplies disclosed herein can utilize common power management technologies such as replaceable and rechargeable batteries, supply regulation technologies, and/or charging system technologies for supplying energy to the components of an associated system, device and/or module to facilitate long-range or short-range portable communications. Alternatively, or in combination, the charging system can utilize external power sources such as DC power supplied over a physical interface such as a USB port or other suitable tethering technologies.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A configurable optical signal distribution device, comprising:
a housing comprising an upstream optical terminal, a diversion optical terminal, and a first plurality of downstream optical terminals;
an adjustable optical signal diverter comprising an upstream optical port optically coupled to the upstream optical terminal, a diversion optical port optically coupled to the diversion optical terminal, and a downstream optical port in communication with the first plurality of downstream optical terminals;
an adjustable diversion selector coupled to the adjustable optical signal diverter, wherein the adjustable optical signal diverter is configured to direct a selectable portion of a downstream optical signal presented at the diversion optical terminal to the diversion optical terminal, and wherein a value of the selectable portion is determined according to an adjustment of the adjustable diversion selector; and
a first optical signal splitter optically coupled between the diversion optical port and the first plurality of downstream optical terminals, wherein the selectable portion of the downstream optical signal is divided among the first plurality of downstream optical terminals.

2. The configurable optical signal distribution device of claim 1, wherein the adjustable optical signal diverter further comprises first and second optical waveguide segments, wherein the first optical waveguide segment is in optical communication with the upstream optical terminal and wherein the second optical waveguide segment is in optical communication with the first plurality of downstream optical terminals.

3. The configurable optical signal distribution device of claim 2, wherein the selectable portion of the downstream optical signal presented at the diversion optical terminal is responsive to relative positions of the first and second optical waveguide segments.

4. The configurable optical signal distribution device of claim 3, wherein the relative positions of the first and second optical waveguide segments is determined according to a setting of the adjustable diversion selector.

5. The configurable optical signal distribution device of claim 1, further comprising:
an indicator configured to provide an indication of the selectable portion of the downstream optical signal presented at the diversion optical terminal.

6. The configurable optical signal distribution device of claim 5, wherein the adjustable diversion selector further comprises one of a lever, a knob, a button, or a combination thereof, and wherein the indicator is configured to provide the indication of the selectable portion, according to an orientation of the adjustable diversion selector.

7. The configurable optical signal distribution device of claim 1, wherein the housing further comprises:
a second plurality of downstream optical terminals; and
an expansion receiving area configured to accept a second optical signal splitter.

8. The configurable optical signal distribution device of claim 7, further comprising:
a second optical signal splitter received in the expansion receiving area, wherein the second optical signal splitter is optically coupled between the diversion optical port and the second plurality of downstream optical terminals, wherein the selectable portion of the downstream optical signal is divided among the first plurality of downstream optical terminals and the second plurality of downstream optical terminals.

9. The configurable optical signal distribution device of claim 7, wherein the expansion receiving area further comprises a mounting receptable configured to securely retain the second optical signal splitter when received therein.

10. The configurable optical signal distribution device of claim 1, wherein at least one of the upstream optical terminal, the diversion optical terminal, and the plurality of downstream optical terminals comprises an optical fiber segment adapted to adjoin a separate optical fiber using an optical fiber splice.

11. The configurable optical signal distribution device of claim 1, wherein at least one of the upstream optical terminal, the diversion optical terminal, and the plurality of downstream optical terminals comprises an optical connector adapted for repeated connections.

12. The configurable optical signal distribution device of claim 1, wherein the downstream optical signal is divided substantially equally among the plurality of downstream optical terminals.

13. A method, comprising:
determining requirements for distributing a downstream optical signal to a plurality of optical terminals;
determining a first configuration of a first optical signal distribution module based on the requirements for distributing a downstream optical to obtain a first determined configuration of the first optical signal distribution module;
determining a second configuration of a second optical signal distribution module, differing from the first configuration and based on the requirements for distributing the downstream optical to obtain a second determined configuration of the second optical signal distribution module, wherein the first and second optical signal distribution modules are similar;
configuring the first optical signal distribution module according to the first determined configuration to obtain a configured first optical signal distribution module;
configuring the second optical signal distribution module according to the second determined configuration to obtain a configured second optical signal distribution module; and
operating the configured first optical signal distribution module and the configured second optical signal distribution module to distribute selectable portions of the downstream optical signal to the plurality of optical terminals according to the requirement.

14. The method of claim 13, wherein the first configuration of a first optical signal distribution module determines a portion of the downstream optical signal diverted to a first group of the plurality of optical terminals.

15. The method of claim 14, wherein the first configuration of a first optical signal distribution module further comprises adjusting an adjustable optical coupler, wherein the portion of the downstream optical signal diverted to the first group of the plurality of optical terminals is responsive to the adjusting of the adjustable optical coupler.

16. The method of claim 15, wherein the adjusting the adjustable optical coupler comprises a manual process without requiring a power source.

17. The method of claim 15, wherein the adjusting the adjustable optical coupler comprises an automated process.

18. A configurable optical signal distribution system, comprising:
a first configurable optical signal distribution device comprising a first upstream optical port configured to receive a downstream optical signal, a first optical tap port in optical communication with a first plurality of downstream optical terminals and a downstream optical port, wherein the first configurable optical signal distribution device is configured according to a first diversion that directs a first diverted portion of the downstream optical signal toward the first optical tap port and a non-diverted portion of the downstream optical signal toward the downstream optical port; and
a second configurable optical signal distribution device comprising a second upstream optical port in communication with the downstream optical port, and a second optical tap port in communication with a second plurality of downstream optical terminals, wherein the second configurable optical signal distribution device is configured according to a second diversion that diverts a second portion of the non-diverted portion of the downstream optical signal toward the second optical tap port,
wherein the first and second configurable optical signal distribution devices are structurally identical, and
wherein the first and second diversions are different.

19. The configurable optical signal distribution system of claim 18, wherein the first configurable optical signal distribution device further comprises a first optical splitter device, wherein the first optical tap port in optical communication with a first plurality of downstream optical terminals.

20. The configurable optical signal distribution system of claim 18, wherein the first and second configurable optical signal distribution devices are passive devices configured for manual configuration and operation within a passive optical network.
